(19) United States
(12) Patent Application Publication
(10) Pub. No.: US 2013/0081217 A1
(43) Pub. Date: Apr. 4, 2013

(54) MOTORIZED MOUTHPIECE

(71) Applicant: Wonjung Jeong, Los Angeles, CA (US)

(72) Inventor: Wonjung Jeong, Los Angeles, CA (US)

(21) Appl. No.: 13/251,043

(22) Filed: Sep. 30, 2011

(51) Int. Cl. A61C 17/02

(52) U.S. Cl. 15/21.1

(57) ABSTRACT

An oral care instrument, such as a customized mouthpiece, which is motorized to brush teeth and activate prescribed irrigative cleaning agents, is described. The user's own mouthpiece is prescribed by providing a mold. It is possibly made of several different substances, onto which will be designed the needed elements to activate the cleaning process in the congenial method, according to the severity of the user's oral condition. The different elements used to customize the prescription will consist of various features, including bristles that are changed to pre-selected angular dispositions according to the user's condition. The motorized mouthpiece will also contain tiny jet nozzles that shoot pulsating jets of pressurized water, combined with other cleaning agents to cure and prevent the user of developing oral diseases.

### FIELD OF THE INVENTION

The present invention relates to the medical equipment category and is sub-classified as a dental mouthpiece. The invention is a motorized mouthpiece, containing bristles and jet nozzles that shoot water and other solvents. The jet nozzles are used to irrigate and clean human teeth. The technical aspect of the invention provides user a fully motorized and non-manual method of brushing and cleaning teeth. It minimizes the physical activity involved in the brushing motion, and the steps required to administer the proper cleaning agents.

### BACKGROUND OF THE INVENTION

Various traditional manual toothbrushes, including but not limited to, a state of the art motorized technologies have been developed to protect the white, calcified structure within human mouth. Among these are U.S. Pat. No. 6,743,249 to Alden, U.S. Pat. No. 5,030,098 to Branford, U.S. Pat. No. 4,883,046 to Fontenot, U.S. Pat. No. 5,573,399 to McClintock, II, U.S. Pat. No. 4,944,947 to Newman, U.S. Pat. No. 4,898,535 to Bergersen. All these inventions are related to in methods and devices to the dental treatment. The closest to the present invention, in nature, is U.S. Pat. No. 4,883,046 to Fontenot and U.S. Pat. No. 4,944,947 to Newman.

Fontenot's invention is a mandible oscillator system which has an intraoral appliance mounted onto the upper and lower arches. A linear stepper motor forcibly imparts oscillating motion to the intraoral appliance. During one-half cycle of oscillation the lower arch is forced to move away from the upper arch. During the other half cycle, the lower arch is forced to move toward the upper arch. A programmable digital computer drives the motor and adjusts the parameters of the oscillating motion. A linear stepper motor in Fontenot's invention is similar to the motorized mouthpiece in the present invention. Fontenot's invention does not have bristles and jet nozzles that are activated simultaneously.

U.S. Pat. No. 4,944,947 to Newman is a dental appliance useful for treating teeth and mouth tissue. The appliance is in a form of a sterilized block of foam material, comprised of a mixture of a water-activated, hydrophilic foam polymer with an aqueous treatment solution, containing effective amount of a therapeutic composition. The block has a predetermined shape containing aqueous treatment solution, for a dental therapeutic use. Water activated in Newman's invention is similar to jet nozzles that shoot water and solvents. Newman's invention does not teeth use of tap water presence jet nozzles for pulsating jets of pressurized water. The present invention has a tap water pressured mouthpiece that is customized with bristles. Jet nozzles are customized in the present invention.

Although Fontenot's invention and Newman's invention appear to function similarly to the present invention, the present invention possesses distinctive advantages over the prior art, which will be pointed out in more particularity later.

### BRIEF SUMMARY OF THE INVENTION

The present invention is a mouthpiece, customized with bristles and jet nozzles that are activated simultaneously. Three main elements of this invention are consisted of two sets of customized bristles. One is a shorter set to cover the main surface of the teeth and the other is a longer and softer set to cover recessed contours of the teeth that conjoin with human gum. The third element is an irrigative ‘jet nozzles’ that is connected to a fluid source, via tube. It is customized to pre-selected positions, to administer cleaning agents. After this process, the nozzles shoot pulsating jets of pressurized water to cleanse the waste away from the teeth. The ‘jet nozzles’ supply the water streaming pressure via cord from a tap. Regulation and control of the required power thru a ‘pressure regulator’ to a desired water pressure at 0.1-1.0 PSI (pounds per square inch) are achieved by water. These three elements are customized by using a dental mold. The present invention will provide not only brushing our teeth but also attacking the deeply hidden problem areas with water jet nozzles. A fluid movement of jet nozzles pulsates within our mouth, using external power source over the counter available.

These together with other objects of the invention are pointed out clearly in the claims annexed to and forming the embodiment of present disclosure. For a better understanding of the present invention, references should be made to the accompanying drawings and descriptive matter, in which are illustrated preferred embodiments of the invention.

### BRIEF DESCRIPTION OF THE DRAWINGS

For the better understanding of the nature of the present invention, reference should be made to the following figures:

FIG. 1 depicts an overall view of a completely automated and motorized dental cleaning mouthpiece apparatus.

FIG. 2 depicts the inner components of the motorized mouthpiece.

FIG. 3 depicts the mouthpiece equipped with jet nozzles that perform the needed irrigation during and after the wash.

### DETAILED DESCRIPTION OF THE PREFERRED EMBODIMENT

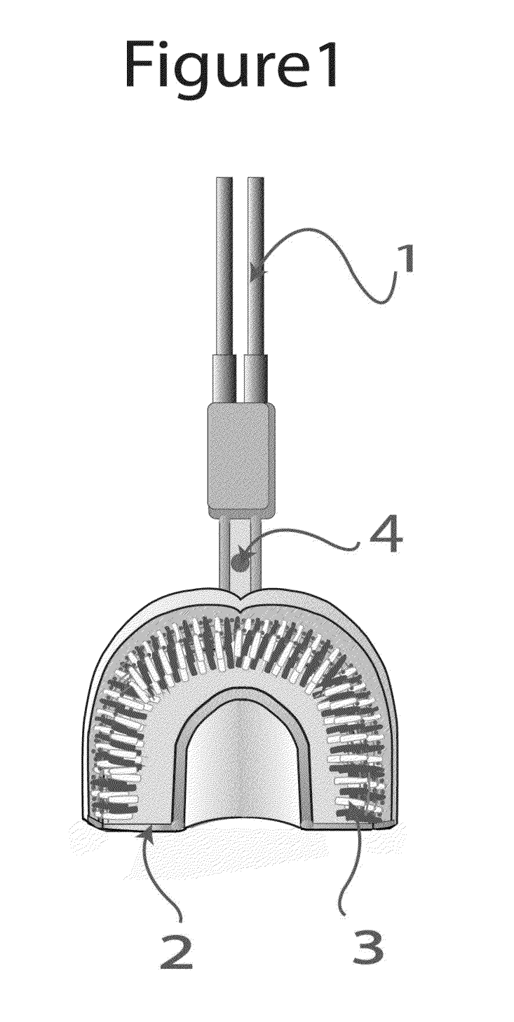

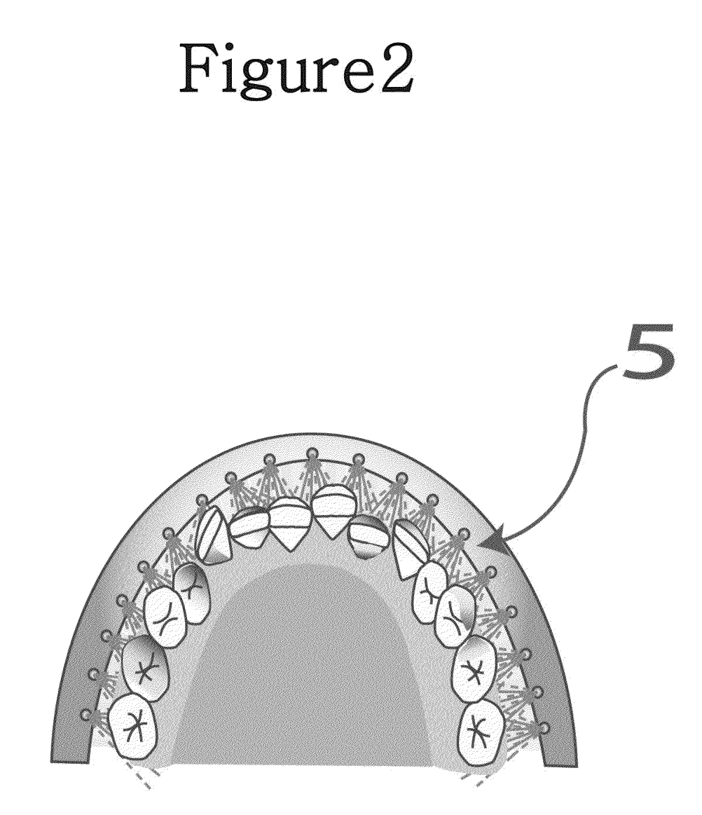

Referring now to FIG. 1, is an overall view of the completely automated and motorized dental cleaning mouthpiece apparatus. The mouthpiece 2 is connected to the fluid source via a tube 1 that will also be made with a special material that facilitates the free flow of the needed dentifrice. The dentifrice is supplied into the mouthpiece 2. Mouthpiece 2 begins to perform the required vibratory motion depending on a user's sensitivity. The motorized mouthpiece 2 will perform the required brushing thru two sets of bristles 3. Longer bristle set covers the area that conjoins the teeth and gum and shorter bristle set covers the remaining surface area hidden. The last component of the apparatus is the small control panel 4 that allows the user to start and finish the brushing process. The control panel 4 allows the user to control the amount of water pressure. FIG. 2 shows the jet nozzles 5 in the mouthpiece that shoot pressurized water to irrigate the teeth, especially in between the teeth while the brushing occurs.

FIG. 2 shows the mouthpiece will also come equipped with jet nozzles that perform the needed irrigation during and after the wash. The jet nozzles will shoot streams of pressurized water to not only irrigate during and after the wash, but also to make the brushing more effective and closer to the actual surfaces of the teeth and mouth.

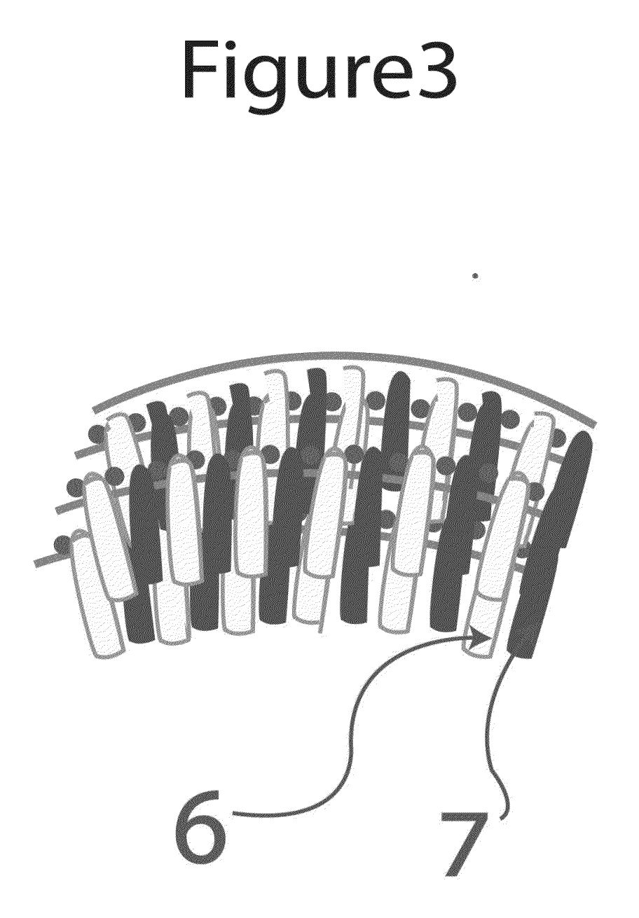

FIG. 3 shows the inner components of the motorized mouthpiece. The mouthpiece will accomplish the needed cleansing through two sets of bristles. One is a shorter set 6 to cover the main surface of the teeth and the other is a longer and softer set 7 to cover recessed contours of the teeth that conjoin with human gum. One short and white set 6 will cover the immediate area that conjoins the teeth and gums. The other longer blue set 7 will reach into the outer tips of the teeth, and especially into the crevices that are difficult to reach without pre-selecting the angular dispositions. The bristles will be mounted into pre-selected angular dispositions according to the user's contours and constrictions. The bristles will be mounted into prescribed angular positions by dental professionals; allowing the user to attack the plaque that builds in the crevices, instead of the general surface area of the teeth. Therefore, the features in the present invention will provide the user with a total solution for brushing, cleaning, and flushing of the teeth, gums, and other general areas of the mouth and does not require any manual motion from the user.

Particular features of the invention are emphasized in the claims which follow.

What is claimed is:

1. Dental treatment apparatus comprised of: (1) dental tray; (2) water pressurized squeezing bag in which exists water spray nozzles and expansion elastic wall and bristles pointing at interface between tooth and gum; (3) temperature controlled water inlet tube; (4) water outlet tube; (5) bristle vibrator.

2. The bristles in claim 1 are customized according to the user's contours and constrictions.

3. The bristles in claim 1 are seasoned of one short and white set will cover the immediate area that conjoins the teeth and gums and the longer blue set will reach into the outer tips of the teeth, and especially into the crevices that are difficult to reach without pre- selecting the angular dispositions.
